(19) United States
(12) Patent Application Publication
(10) Pub. No.: US 2024/0340919 A1
(43) Pub. Date: Oct. 10, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Bin LIANG, Dongguan (CN); Yanan LIN, Dongguan (CN); Jing XU, Dongguan (CN); Yi ZHANG, Dongguan (CN)

(21) Appl. No.: 18/746,741

(22) Filed: Jun. 18, 2024

Related U.S. Application Data
(63) Continuation of application No. PCT/CN2021/143558, filed on Dec. 31, 2021.

(51) Int. Cl. H04W 72/232; H04W 72/12

(52) U.S. Cl. CPC H04W 72/232; H04W 72/12

(57) ABSTRACT

A wireless communication method, a terminal device, and a network device are provided. The wireless communication method includes: detecting, by a terminal device, DCI, where a format of the DCI is a first format, the DCI is used to schedule data transmission of at least two carriers, and the first format is one of a plurality of DCI formats; where if a quantity of DCI sizes corresponding to the plurality of DCI formats does not meet a preset condition, alignment processing is performed on DCI corresponding to the plurality of DCI formats to meet the preset condition.

### CROSS-REFERENCE TO RELATED APPLICATIONS

This application is a continuation of International Application No. PCT/CN2021/143558, filed on Dec. 31, 2021, the disclosure of which is hereby incorporated by reference in its entirety.

### TECHNICAL FIELD

This application relates to the field of communications technologies, and more specifically, to a wireless communication method, a terminal device, and a network device.

### RELATED ART

A network device may configure different downlink control information (DCI) formats for a terminal device, to be applicable to different scenarios and scheduling requirements configured by the network device. Some communications systems, such as a new radio (NR) system, may introduce a new DCI format. DCI corresponding to the new DCI format may schedule one or more carriers corresponding to the terminal device.

However, in the foregoing scenario, due to introduction of the new DCI format, a limitation related to a quantity of DCI sizes may not be met. For example, a limitation that the terminal device supports a limited quantity (4) of DCI sizes is not met, or a limitation that a quantity of DCI sizes of DCI scrambled by a cell-radio network temporary identifier (C-RNTI) does not exceed 3 is not met.

### SUMMARY

This application provides a wireless communication method, a terminal device, and a network device, to resolve a problem of how to meet a limitation related to a quantity of DCI sizes after a new DCI format is introduced.

According to a first aspect, a wireless communication method is provided, including: detecting, by a terminal device, DCI, where a format of the DCI is a first format, the DCI is used to schedule data transmission of at least two carriers, and the first format is one of a plurality of DCI formats; where if a quantity of DCI sizes corresponding to the plurality of DCI formats does not meet a preset condition, alignment processing is performed on DCI corresponding to the plurality of DCI formats to meet the preset condition.

According to a second aspect, a wireless communication method is provided, including: transmitting, by a network device, DCI to a terminal device, where a format of the DCI is a first format, the DCI is used to schedule data transmission of at least two carriers, and the first format is one of a plurality of DCI formats; where if a quantity of DCI sizes corresponding to the plurality of DCI formats does not meet a preset condition, alignment processing is performed on DCI corresponding to the plurality of DCI formats to meet the preset condition.

According to a third aspect, a terminal device is provided, including: a detection module, configured to detect DCI, where a format of the DCI is a first format, the DCI is used to schedule data transmission of at least two carriers, and the first format is one of a plurality of DCI formats; where if a quantity of DCI sizes corresponding to the plurality of DCI formats does not meet a preset condition, alignment processing is performed on DCI corresponding to the plurality of DCI formats to meet the preset condition.

According to a fourth aspect, a network device is provided, including: a transmitting module, configured to transmit DCI to a terminal device, where a format of the DCI is a first format, the DCI is used to schedule data transmission of at least two carriers, and the first format is one of a plurality of DCI formats; where if a quantity of DCI sizes corresponding to the plurality of DCI formats does not meet a preset condition, alignment processing is performed on DCI corresponding to the plurality of DCI formats to meet the preset condition.

According to a fifth aspect, a terminal device is provided, including a processor, a memory, and a communications interface. The memory is configured to store one or more computer programs, and the processor is configured to invoke the computer program in the memory to cause the terminal device to execute some or all of the steps in the method according to the first aspect.

According to a sixth aspect, a network device is provided, including a processor, a memory, and a communications interface. The memory is configured to store one or more computer programs, and the processor is configured to invoke the computer program in the memory to cause the network device to execute some or all of the steps in the method according to the second aspect.

According to a seventh aspect, an embodiment of this application provides a communications system, where the system includes the foregoing terminal device and/or the foregoing network device. In another possible design, the system may further include another device that interacts with the terminal device or the network device in the solutions provided in embodiments of this application.

According to an eighth aspect, an embodiment of this application provides a computer-readable storage medium, where the computer-readable storage medium stores a computer program, and the computer program causes a terminal device to execute some or all of the steps in the method according to the first aspect.

According to a ninth aspect, an embodiment of this application provides a computer-readable storage medium, where the computer-readable storage medium stores a computer program, and the computer program causes a network device to execute some or all of the steps in the method according to the second aspect.

According to a tenth aspect, an embodiment of this application provides a computer program product, where the computer program product includes a non-transitory computer-readable storage medium that stores a computer program, and the computer program is operable to cause a terminal device to execute some or all of the steps in the method according to the first aspect. In some implementations, the computer program product may be a software installation package.

According to an eleventh aspect, an embodiment of this application provides a computer program product, where the computer program product includes a non-transitory computer-readable storage medium that stores a computer program, and the computer program is operable to cause a network device to execute some or all of the steps in the method according to the second aspect. In some implementations, the computer program product may be a software installation package.

According to a twelfth aspect, an embodiment of this application provides a chip, where the chip includes a memory and a processor, and the processor may invoke a computer program from the memory and run the computer program, to implement some or all of the steps described in the method according to the first aspect or the second aspect.

### BRIEF DESCRIPTION OF DRAWINGS

FIG. 1 is an example diagram of an architecture of a wireless communications system that may be applied to an embodiment of this application.

FIG. 2 is a schematic flowchart of a wireless communication method according to an embodiment of this application.

FIG. 3 is a schematic flowchart of alignment processing according to an embodiment of this application.

FIG. 4 is a schematic flowchart of alignment processing according to another embodiment of this application.

FIG. 5 is a schematic structural block diagram of a terminal device according to an embodiment of this application.

FIG. 6 is a schematic structural block diagram of a network device according to an embodiment of this application.

FIG. 7 is a schematic structural diagram of an apparatus according to an embodiment of this application.

### DESCRIPTION OF EMBODIMENTS

### Architecture of a Communications System

FIG. 1 shows a wireless communications system 100 to which an embodiment of this application is applied. The wireless communications system 100 may include a network device 110 and a terminal device 120. The network device 110 may be a device that communicates with the terminal device 120. The network device 110 may provide communication coverage for a specific geographic area, and may communicate with a terminal device 120 within the coverage area.

FIG. 1 exemplarily shows one network device and two terminals. Optionally, the wireless communications system 100 may include a plurality of network devices, and another quantity of terminal devices may be included within a coverage range of each network device, which is not limited in embodiments of this application.

Optionally, the wireless communications system 100 may further include other network entities such as a network controller and a mobility management entity, which is not limited in embodiments of this application.

It should be understood that the technical solution in embodiments of this application may be applied to various communications systems, such as a fifth generation (5G) system or new radio (NR), a long term evolution (LTE) system, an LTE frequency division duplex (FDD) system, and LTE time division duplex (TDD). The technical solutions provided in this application may further be applied to a future communications system, such as a sixth generation mobile communications system or a satellite communications system.

The terminal device in embodiments of this application may also be referred to as a user equipment (UE), an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or an in-vehicle device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the UE may be used as a base station. For example, the UE may act as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying a communication signal by using a base station.

The network device in embodiments of this application may be a device configured to communicate with the terminal device. The network device may also be referred to as an access network device or a wireless access network device. For example, the network device may be a base station. The network device in embodiments of this application may be a radio access network (RAN) node (or device) that connects the terminal device to a wireless network. The base station may broadly cover various names in the following, or replace with the following names, for example: a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device to device (D2D), vehicle-to-everything (V2X), and machine-to-machine (M2M) communications, a network-side device in a 6G network, a device that functions as a base station in a future communications system, or the like. The base station may support networks of a same or different access technologies. A specific technology and a specific device form used by the network device are not limited in embodiments of this application.

The base station may be fixed or mobile. For example, a helicopter or an unmanned aerial vehicle may be configured to act as a mobile base station, and one or more cells may move depending on a location of the mobile base station. In other examples, a helicopter or an unmanned aerial vehicle may be configured to serve as a device communicating with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or in-vehicle, may be deployed on a water surface, or may be deployed on a plane, a balloon, or a satellite in the air. In embodiments of this application, a scenario in which the network device and the terminal device are located is not limited.

It should be understood that all or some of functions of the communications device in this application may also be implemented by software functions running on hardware, or by virtualization functions instantiated on a platform (for example, a cloud platform).

### Formats of DCI

In a communications system (for example, an NR system), downlink resource scheduling of a cell in a network may be indicated by DCI. The DCI may be carried on a physical downlink control channel (PDCCH). A terminal device may detect and demodulate the DCI in the PDCCH, and then demodulate, based on information indicated by the DCI, a physical downlink shared channel (PDSCH) belonging to the terminal device at a corresponding resource position, including demodulating a broadcast message, paging, data of the terminal device, and the like.

A plurality of DCI formats may be supported in a communications system. For example, in an NR system, DCI format 0_0, DCI format 1_0, DCI format 0_1, DCI format 1_1, DCI format 0_2, DCI format 1_2, DCI format 2_1, DCI format 2_2, DCI format 2_3, DCI format 2_4, DCI format 2_5, and DCI format 2_6 may be supported. Different DCI formats may be used for different purposes, such as data scheduling, resource preemption, slot format notification, transmission preemption, cell sleep, and uplink power control.

In some embodiments, the DCI may be classified into DCI for scheduling downlink (downlink, DL) data transmission and DCI for scheduling uplink (UL) data transmission according to a transmission direction. For example, in the NR system, the DCI format 0_0, the DCI format 0_1, and the DCI format 0_2 may be used to schedule uplink data transmission, while the DCI format 1_0, the DCI format 1_1, and the DCI format 1_2 may be used to schedule downlink data transmission.

In some embodiments, the DCI may be classified into DCI in a fallback format (fallback DCI) and DCI in a non-fallback format (non-fallback DCI) according to whether the DCI is configured independently of higher layer signalling specific to the terminal device or according to a function of the DCI. The DCI in the fallback format may also be referred to as fallback DCI, and the DCI in the non-fallback format may also be referred to as non-fallback DCI. The DCI in the fallback format is generally used for scheduling of a common message and in an initial access process, and is mainly used for some basic functions. A size range of the DCI is relatively fixed, and is less than that of another DCI format. For example, the DCI format 0_0 and the DCI format 1_0 in the NR system are the DCI in the fallback format. The DCI in the non-fallback format is generally used for scheduling dedicated information of the terminal device, and a size of the DCI changes in a relatively large range. In addition, a size of the DCI in the non-fallback format depends on a function supported by a current system. For example, a system provides few functions, and the size of the DCI in the non-fallback format may be very small. However, if a system provides many functions, the size of the DCI in the non-fallback format may be large. For example, the DCI format 0_1, the DCI format 1_1, the DCI format 0_2, and the DCI format 1_2 in the NR system are DCI in the non-fallback format.

It should be noted that the DCI for scheduling downlink data transmission and the DCI for scheduling uplink data transmission may be in different formats. The DCI in the fallback format and the DCI in the non-fallback format may be in different formats.

It should be noted that, in some embodiments, the DCI format 0_0 and the DCI format 1_0 may be referred to as a same format, where the DCI format 0_0 is used to schedule uplink data transmission, and the DCI format 1_0 is used to schedule downlink data transmission. In other words, DCI corresponding to the DCI format 0_0 and DCI corresponding to the DCI format 1_0 may be referred to as DCI in a same format and correspondingly used to schedule uplink data transmission and downlink data transmission. Similarly, the DCI format 0_1 and the DCI format 1_1 may be referred to as a same format, where the DCI format 0_1 is used to schedule uplink data transmission, and the DCI format 1_1 is used to schedule downlink data transmission. The DCI format 0_2 and the DCI format 1_2 may be referred to as a same format, where the DCI format 0_2 is used to schedule uplink data transmission, and the DCI format 1_2 is used to schedule downlink data transmission.

### DCI Scrambling

In some embodiments, when a network device transmits DCI, for example, DCI in a fallback format or DCI in a non-fallback format, to a terminal device, if the DCI is used to schedule data transmission specific to the terminal device, a radio network temporary identifier (RNTI) specific to the terminal device may be used to scramble the DCI. For example, if the DCI is used to schedule a PDSCH or a physical uplink shared channel (PUSCH), and data transmission performed on the PDSCH or the PUSCH is specific to the terminal device, the RNTI specific to the terminal device may be used to scramble the DCI.

There may be a plurality of types of RNTIs specific to the terminal device. This is not limited in embodiments of this application. For example, the RNTI specific to the terminal device may be a cell RNTI (C-RNTI), or a configured scheduling RNTI (CS-RNTI), or a modulation and coding scheme cell RNTI (MCS-C-RNTI) of the terminal device, or the like.

The C-RNTI is an important identifier for the network device to identify the terminal device at a level of an access network. The network device uses the C-RNTI to scramble DCI, which is equivalent to that encrypted transmission of the DCI is performed between the network device and the terminal device by using the C-RNTI.

In some embodiments, when the network device transmits the DCI, for example, the DCI in the fallback format, to the terminal device, if the DCI is used to schedule a cell system message, schedule a group of terminal devices, or schedule a terminal device in a non-connected state, a common RNTI may be used to scramble the DCI. For example, a common RNTI such as a system message RNTI (SI-RNTI), a paging RNTI (P-RNTI), or a random access RNTI (RA-RNTI) may be used to scramble the DCI.

### DCI Size

DCI sizes corresponding to different DCI formats may be different. A DCI size may be specifically a payload size of DCI, or may be a quantity of bits included in the DCI. When detecting DCI, a terminal device performs blind detection on a PDCCH. Therefore, a large quantity of DCI sizes corresponding to a DCI format indicates a large quantity of blind detection times in a process in which the terminal device performs blind detection on the PDCCH at each resource position. A relatively large amount of computation and storage of the terminal device may be occupied in the detection process, resulting in relatively high complexity of the terminal device.

To limit the complexity of the terminal device, release 15 (R15) of NR specifies that in a scheduled carrier corresponding to the terminal device, a quantity of DCI sizes that may be supported by the carrier does not exceed 4, and a quantity of sizes of DCI scrambled by a C-RNTI does not exceed 3. In some embodiments, the carrier may also be referred to as a cell.

In some communications systems (for example, a 5G NR system), a network device may configure different DCI formats for the terminal device, to be applicable to different scenarios and scheduling requirements configured by the network device. For example, different DCI formats may be configured in the 5G NR system, to be applicable to main application scenarios such as enhanced mobile broadband (eMBB), ultra-reliable low latency communications (URLLC), and massive machine type communications (mMTC). In addition, the network device may configure, for each carrier corresponding to the terminal device, one or more available DCI formats corresponding to the carrier. When the network device configures a plurality of DCI formats for a carrier corresponding to the terminal device, DCI sizes corresponding to the plurality of DCI formats may be aligned according to a protocol rule, so that the carrier supports a maximum of four DCI sizes, and a quantity of sizes of DCI scrambled by a C-RNTI cannot exceed 3. The DCI scrambled by the C-RNTI is usually used to schedule a PDSCH and a PUSCH. In addition, a DCI format in the system may be applied to one piece of DCI to schedule one PDSCH or one PUSCH on one carrier.

In one aspect, in some scenarios (for example, a carrier aggregation scenario), when PDCCH resources are limited and a relatively large quantity of carrier resources need to be invoked, if one piece of DCI remains a function of invoking only one carrier, a load of a PDCCH is increased.

In another aspect, to better use limited spectrum resources, in a related technology, a spectrum resource may be shared between 4G and 5G when the network device performs configuration. However, because transmission of a cell-specific reference signal (CRS) in a 4G system must be performed, when a 5G signal is transmitted, an operation such as rate matching needs to be performed at a corresponding resource position, to avoid interference between the 4G signal and the 5G signal. However, the rate matching affects performance in transmission of data or control information (for example, DCI). To avoid a resource of the CRS in the 4G system, resources that may be used for 5G PDCCH transmission are limited.

Based on this, some communications systems (for example, the NR system) may introduce a new DCI format. DCI corresponding to the new DCI format may schedule one or more carriers corresponding to a terminal device.

However, in the foregoing scenario, after the new DCI format is introduced, a DCI size corresponding to the new DCI format may be different from an existing DCI size, and therefore, a limitation related to a quantity of DCI sizes may not be met. For example, a limitation that the terminal device supports a limited quantity (4) of DCI sizes is not met, or a limitation that a quantity of DCI sizes of DCI scrambled by a C-RNTI does not exceed 3 is not met.

In embodiments of this application, the limitation related to the quantity of DCI sizes may also be referred to as a preset condition. For example, the preset condition may be that the quantity of DCI sizes that may be supported by a carrier corresponding to the terminal device does not exceed 4, or the quantity of the sizes of the DCI scrambled by the C-RNTI that may be supported by a carrier corresponding to the terminal device does not exceed 3.

In view of this, embodiments of this application provide a wireless communication method, a terminal device, and a network device, to resolve a problem of how to meet a limitation related to a quantity of DCI sizes (a preset condition) after a new DCI format is introduced. The following describes embodiments of this application in detail.

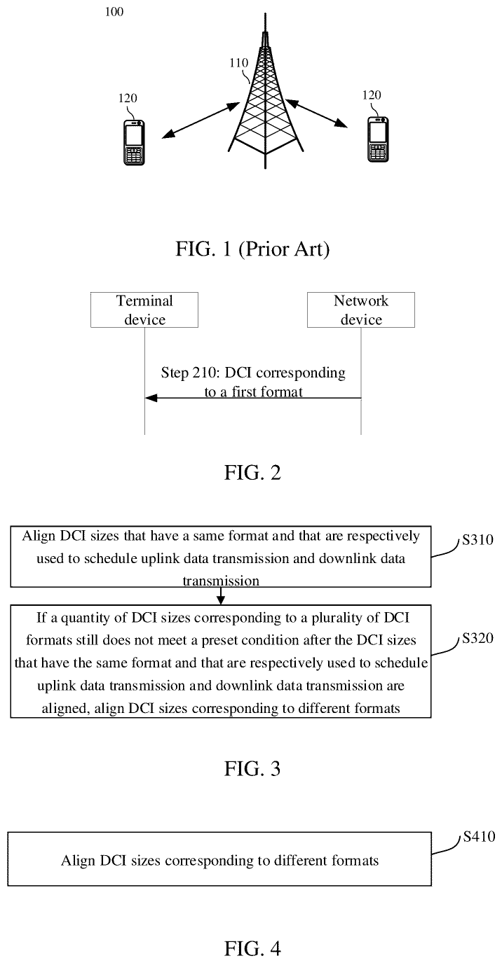

FIG. 2 is a schematic flowchart of a wireless communication method according to an embodiment of this application. The method shown in FIG. 2 is described from a perspective of interaction between a terminal device and a network device. The terminal device and the network device may be, for example, the terminal device and the network device shown in FIG. 1. The method shown in FIG. 2 includes step S210. The following describes this step in detail.

In step S210, the terminal device detects DCI. The DCI is DCI corresponding to a first format. The DCI corresponding to the first format may be used to schedule data transmission of at least two carriers corresponding to the terminal device. In some embodiments, detecting, by the terminal device, the DCI corresponding to the first format may also be referred to as detecting, by the terminal device, a PDCCH that carries the first format.

The DCI corresponding to the first format may schedule the data transmission of the at least two carriers corresponding to the terminal device. In one aspect, a load of the PDCCH may be reduced. In another aspect, DCI transmission may be reduced, so that it may be ensured that DCI transmission is performed on a resource that does not overlap a CRS in a 4G network as much as possible. This avoids an impact of rate matching and the CRS on performance of the PDCCH or the DCI transmission.

The first format may be a DCI format configured by the network device. In some embodiments, the network device may configure a DCI format by using higher layer signalling (for example, radio resource control (RRC) signalling).

Optionally, the DCI in the first format may include DCI used to schedule uplink data transmission and/or DCI used to schedule downlink data transmission. The DCI used to schedule uplink data transmission and the DCI used to schedule downlink data transmission may be referred to as DCI in a same format (the first format) and correspondingly used to schedule uplink data transmission and downlink data transmission. For example, the DCI in the first format may include DCI format 0_3 and/or DCI format 1_3. The DCI format 0_3 is used to schedule uplink data transmission, and the DCI format 1_3 is used to schedule downlink data transmission. It should be noted that, for ease of description, in embodiments of this application, the first format is denoted as the DCI format 0_3 and/or the DCI format 1_3. However, embodiments of this application are not limited thereto. The DCI in the first format may also have another identification manner. For example, the first format may be DCI format 0_4 and/or DCI format 1_4, provided that the first format is substantially unchanged.

Optionally, the DCI in the first format may distinguish, by using a DCI format indication in a DCI indication field, whether the DCI in the first format is used to schedule uplink data transmission or downlink data transmission. For example, a value of 0 may be used to indicate scheduling of uplink data transmission, and a value of 1 may be used to indicate scheduling of downlink data transmission. That is, in the DCI in the first format, one bit may be used to indicate the DCI format indication of the DCI.

Optionally, the indication field of the DCI in the first format may further include a bandwidth part (BWP) indication, frequency domain resource allocation, time domain resource allocation, a modulation and coding scheme, a new data indicator, a redundancy version, a hybrid automatic repeat request (HARQ) process number, and the like. This application is not specifically limited thereto.

Optionally, the indication field of the DCI in the first format may further include a carrier indication. The carrier indication may be used to distinguish between carriers that are corresponding to the terminal device and that are scheduled by using the DCI in the first format.

It should be noted that embodiments of this application are not limited thereto. In some embodiments, the DCI corresponding to the first format may be further used to schedule data transmission of one carrier corresponding to the terminal device.

It should be noted that the first format is one of a plurality of DCI formats. If a quantity of DCI sizes corresponding to the plurality of DCI formats does not meet a preset condition, alignment processing may be performed on the DCI corresponding to the plurality of DCI formats to meet the preset condition.

In embodiments of this application, before the alignment processing is performed on the DCI, a DCI size corresponding to an alignment operation is first determined. For example, a maximum value of all DCI sizes corresponding to a current DCI format that is to be aligned may be determined as the DCI size corresponding to the current alignment operation, or a minimum value of all the DCI sizes corresponding to the current DCI format that is to be aligned may be determined as the DCI size corresponding to the current alignment operation. Alternatively, the DCI size corresponding to the alignment operation may be selected based on a type of the current DCI format that is to be aligned. For example, a DCI size of a DCI format that is in the current DCI format to be aligned and that is used to schedule a downlink is determined as the DCI size corresponding to the current alignment operation, or a DCI size of a DCI format that is in the current DCI format to be aligned and that is used to schedule an uplink is determined as the DCI size corresponding to the current alignment operation. In some embodiments, the plurality of DCI formats may be DCI formats configured by the network device for the terminal device. In some embodiments, the plurality of DCI formats may be DCI formats supported by the terminal device.

In some embodiments, the preset condition may include: a quantity of DCI sizes supported by a carrier corresponding to the terminal device is less than or equal to 4; or, a quantity of DCI sizes of DCI scrambled by a C-RNTI that is supported by the carrier corresponding to the terminal device is less than or equal to 3. It should be noted that the carrier corresponding to the terminal device may be at least one of a plurality of carriers (at least two carriers) corresponding to the DCI in the first format. For example, the DCI in the first format may be used to schedule a first carrier and a second carrier of the terminal device, and the DCI sizes supported by the carrier corresponding to the terminal device may include a DCI size supported by the first carrier or a DCI size supported by the second carrier; or a DCI size supported by each carrier in the first carrier and the second carrier.

With reference to Embodiment 1, following describes in detail how to ensure, through alignment processing, that a quantity of sizes of DCI transmitted by a network device to a terminal device meets a preset condition.

### Embodiment 1

The solution provided in Embodiment 1 may be applied to a scenario in which DCI in a first format is introduced. In some embodiments, the alignment processing in Embodiment 1 may also be applied to the solution in Embodiment 2 in the following, that is, if a preset condition is still not met after a type of configured DCI is limited, the solution of alignment processing in Embodiment 1 may be used. For specific content of Embodiment 2, refer to the following, and details are not described herein again.

FIG. 3 is a schematic flowchart of alignment processing according to an embodiment of this application. As shown in FIG. 3, in some embodiments, the alignment processing may include step S310 and step S320. The following describes these steps in detail.

In step S310, DCI sizes that have a same format and that are respectively used to schedule uplink data transmission and downlink data transmission are aligned. In some embodiments, the foregoing may also be referred to as aligning DCI sizes that have a same format and that are correspondingly used to schedule uplink data transmission and downlink data transmission.

Aligning DCI sizes that have the same format and that are respectively used to schedule uplink data transmission and downlink data transmission may refer to aligning DCI sizes that have the first format and that are respectively used to schedule uplink data transmission and downlink data transmission, or aligning DCI sizes that have a second format and that are respectively used to schedule uplink data transmission and downlink data transmission, or aligning DCI sizes that have a third format and that are respectively used to schedule uplink data transmission and downlink data transmission. Optionally, the second format may refer to a fallback format, such as DCI format 0_0 and DCI format 1_0. The third format may refer to a non-fallback format, such as DCI format 0_1, DCI format 1_1, DCI format 0_2, and DCI format 1_2.

In some embodiments, the DCI sizes that have the same format and that are respectively used to schedule uplink data transmission and downlink data transmission may be aligned in the following sequence:
(1) Align the DCI sizes that have the second format and that are respectively used to schedule uplink data transmission and downlink data transmission;
(2) If a quantity of DCI sizes corresponding to a plurality of DCI formats still does not meet a preset condition after the DCI sizes that have the second format and that are respectively used to schedule uplink data transmission and downlink data transmission are aligned, align the DCI sizes that have the first format and that are respectively used to schedule uplink data transmission and downlink data transmission; and
(3) If the quantity of DCI sizes corresponding to the plurality of DCI formats still does not meet the preset condition after the DCI sizes that have the first format and that are respectively used to schedule uplink data transmission and downlink data transmission are aligned, align the DCI size that have the third format and that are respectively used to schedule uplink data transmission and downlink data transmission.

As an example, when the plurality of DCI formats include {0_0, 0_2, 0_3, 1_0, 1_2, and 1_3}, DCI sizes corresponding to the DCI formats are different. The DCI format 0_3 and the DCI format 1_3 are the first format, the DCI format 0_0 and the DCI format 1_0 are the second format, and the DCI format 0_2 and the DCI format 1_2 are the third format. DCI sizes corresponding to the DCI format 0_0 and the DCI format 1_0 may be preferably aligned, and a size obtained after the alignment is A. If the preset condition is still not met after the alignment, DCI sizes corresponding to the DCI format 0_3 and the DCI format 1_3 may be aligned, and a size obtained after the alignment is B. If the preset condition is still not met after the alignment, DCI sizes corresponding to the DCI format 0_2 and the DCI format 1_2 may be aligned, and a size obtained after the alignment is C. In this case, a quantity of different DCI sizes corresponding to the plurality of DCI formats is 3, and the preset condition may be met. Certainly, if the preset condition is met after the DCI sizes that have the second format and that are respectively used to schedule uplink data transmission and downlink data transmission are aligned, a subsequent operation may not be performed. That is, if a determining result is that the preset condition is met after an alignment operation is performed each time, a subsequent alignment step may be stopped.

In some other embodiments, the DCI sizes that have the same format and that are respectively used to schedule uplink data transmission and downlink data transmission may be aligned in the following sequence:
(1) Align the DCI sizes that have the second format and that are respectively used to schedule uplink data transmission and downlink data transmission;
(2) If the quantity of DCI sizes corresponding to the plurality of DCI formats still does not meet the preset condition after the DCI sizes that have the second format and that are respectively used to schedule uplink data transmission and downlink data transmission are aligned, align the DCI sizes that have the third format and that are respectively used to schedule uplink data transmission and downlink data transmission; and
(3) If the quantity of DCI sizes corresponding to the plurality of DCI formats still does not meet the preset condition after the DCI sizes that have the third format and that are respectively used to schedule uplink data transmission and downlink data transmission are aligned, align the DCI sizes that have the first format and that are respectively used to schedule uplink data transmission and downlink data transmission.

The example in which the plurality of DCI formats include {0_0, 0_2, 0_3, 1_0, 1_2, and 1_3} is still used. DCI sizes corresponding to the DCI formats are different. The DCI sizes corresponding to the DCI format 0_0 and the DCI format 1_0 may be preferably aligned, and a size obtained after the alignment is A. If the preset condition is still not met after the alignment, the DCI sizes corresponding to the DCI format 0_2 and the DCI format 1_2 may be aligned, and a size obtained after the alignment is B. If the preset condition is still not met after the alignment, the DCI sizes corresponding to the DCI format 0_3 and the DCI format 1_3 may be aligned, and a size obtained after the alignment is C. In this case, a quantity of different DCI sizes corresponding to the plurality of DCI formats is 3, and the preset condition may be met. Similarly, if a determining result is that the preset condition is met after an alignment operation is performed each time, a subsequent alignment step may be stopped.

In embodiments of this application, the DCI sizes corresponding to the second format are preferably aligned based on consideration that DCI corresponding to the second format often carries important common information or important configuration information.

In step S320, if the quantity of DCI sizes corresponding to the plurality of DCI formats still does not meet the preset condition after the DCI sizes that have the same format and that are respectively used to schedule uplink data transmission and downlink data transmission are aligned, DCI sizes corresponding to different formats are aligned.

For example, if the plurality of DCI formats include {0_0, 0_1, 0_2, 0_3, 1_0, 1_1, 1_2, and 1_3}, four types of DCI sizes A, B, C, and D may still exist after the DCI sizes that have the same format and that are respectively used to schedule uplink data transmission and downlink data transmission are aligned according to step S310 (a size obtained after DCI sizes corresponding to the DCI format 0_1 and the DCI format 1_1 are aligned is D), a quantity of DCI sizes of DCI scrambled by a C-RNTI exceeds 3. Therefore, the preset condition is not met. In this case, DCI sizes corresponding to different formats may be aligned. For example, DCI sizes corresponding to the DCI format 0_2 and the DCI format 1_2 may be aligned with DCI sizes corresponding to the DCI format 0_0 and the DCI format 1_0, and a size obtained after the alignment is A. In this case, the plurality of DCI formats include three types of sizes A, C, and D, which may meet the preset condition. Certainly, this application is not limited thereto. For example, alternatively, DCI sizes corresponding to the DCI format 0_3 and the DCI format 1_3 may be aligned with the DCI sizes corresponding to the DCI format 0_0 and the DCI format 1_0, or the DCI sizes corresponding to the DCI format 0_1 and the DCI format 1_1 may be aligned with the DCI sizes corresponding to the DCI format 0_3 and the DCI format 1_3, or the DCI sizes corresponding to the DCI format 0_1 and the DCI format 1_1 may be aligned with the DCI sizes corresponding to the DCI format 0_2 and the DCI format 1_2, provided that the preset condition is met after the alignment.

A manner of alignment used between the DCI formats is not specifically limited in embodiments of this application. For example, DCI with a relatively small quantity of bits may be aligned to DCI with a relatively large quantity of bits through padding. In this manner, information bits in any DCI format may not be lost, and therefore indication accuracy is ensured. Alternatively, DCI with a relatively large quantity of bits may be aligned to DCI with a relatively small quantity of bits through truncation. For example, when DCI corresponding to the DCI format 0_0 and DCI format 1_0 needs to be aligned, if DCI corresponding to the DCI format 1_0 carries an important common message, and a quantity of bits of the DCI format 0_0 is greater than a quantity of bits of the DCI format 1_0, DCI corresponding to the DCI format 0_0 may be aligned to the DCI corresponding to the DCI format 1_0 through truncation. This ensures accuracy of a downlink transmission indication. It should be noted that the alignment processing mentioned in following may also be performing alignment through padding or truncation, and details are not described again in the following.

In embodiments of this application, the DCI sizes that have the same format and that are respectively used to schedule uplink data transmission and downlink data transmission are preferably aligned. This is based on consideration that after the DCI sizes that have the same format and that are respectively used to schedule uplink data transmission and downlink data transmission are aligned, although the DCI sizes are the same, an indication field of DCI may be used to accurately distinguish whether the DCI is used to schedule uplink data transmission or downlink data transmission. This reduces detection complexity of a terminal device.

FIG. 4 is a schematic flowchart of alignment processing according to another embodiment of this application. As shown in FIG. 4, in some embodiments, the alignment processing may include step S410. The following describes this step in detail.

In step S410, DCI sizes corresponding to different formats are aligned.

For example, alignment of DCI sizes corresponding to different formats may refer to alignment of DCI sizes in a first format and used to schedule uplink data transmission and DCI sizes in a second format and used to schedule uplink data transmission, or alignment of DCI sizes in the first format and used to schedule uplink data transmission and DCI sizes in a third format and used to schedule uplink data transmission, or alignment of DCI sizes in the first format and used to schedule downlink data transmission and DCI sizes in the second format and used to schedule downlink data transmission. Embodiments of this application are not limited thereto, provided that DCI in different formats are applied to.

In some embodiments, DCI sizes corresponding to different formats may be aligned in the following sequence:
(1) Align DCI sizes that have the second format and that are respectively used to schedule uplink data transmission and downlink data transmission;
(2) If a quantity of DCI sizes corresponding to a plurality of DCI formats still does not meet a preset condition after the DCI sizes that have the second format and that are respectively used to schedule uplink data transmission and downlink data transmission are aligned, align DCI sizes that have the first format and the third format and that are all used to schedule downlink data transmission; and
(3) If the quantity of DCI sizes corresponding to the plurality of DCI formats still does not meet the preset condition after the DCI sizes that have the first format and the third format and that are all used to schedule downlink data transmission are aligned, align DCI sizes that have the first format and the third format and that are all used to schedule uplink data transmission.

In some embodiments, if the quantity of DCI sizes corresponding to the plurality of DCI formats still does not meet the preset condition after the DCI sizes that have the first format and the third format and that are all used to schedule uplink data transmission are aligned, a plurality of DCI sizes that have the first format and the third format and that are respectively used to schedule uplink data transmission and downlink data transmission may be aligned.

As an example, when the plurality of DCI formats include {0_0, 0_2, 0_3, 1_0, 1_2, and 1_3}, DCI sizes corresponding to the DCI formats are different. DCI sizes corresponding to the DCI format 0_0 and the DCI format 1_0 may be preferably aligned, and a size obtained after the alignment is A. If the preset condition is still not met after the alignment, DCI sizes corresponding to the DCI format 1_2 and the DCI format 1_3 may be aligned, and a size obtained after the alignment is B. If the preset condition is still not met after the alignment, DCI sizes corresponding to the DCI format 0_2 and the DCI format 0_3 may be aligned, and a size obtained after the alignment is C. In this case, the quantity of different DCI sizes corresponding to the plurality of DCI formats is 3, and the preset condition may be met. Certainly, if the preset condition is met after the DCI sizes that have the second format and that are respectively used to schedule uplink and downlink data transmission are aligned or after the DCI sizes corresponding to the DCI format 0_2 and the DCI format 0_3 are aligned, a subsequent operation may not be required. That is, if a determining result is that the preset condition is met after an alignment operation is performed each time, a subsequent alignment step may be stopped.

In some other embodiments, the DCI sizes corresponding to different formats may be aligned in the following sequence:
(1) Align the DCI sizes that have the second format and that are respectively used to schedule uplink data transmission and downlink data transmission;
(2) If the quantity of DCI sizes corresponding to the plurality of DCI formats still does not meet the preset condition after the DCI sizes that have the second format and that are respectively used to schedule uplink data transmission and downlink data transmission are aligned, align the DCI sizes that have the first format and the third format and that are all used to schedule uplink data transmission; and
(3) If the quantity of DCI sizes corresponding to the plurality of DCI formats still does not meet the preset condition after the DCI sizes that have the first format and the third format and that are all used to schedule uplink data transmission are aligned, align DCI sizes that have the first format and the third format and that are all used to schedule downlink data transmission.

In some embodiments, if the quantity of DCI sizes corresponding to the plurality of DCI formats still does not meet the preset condition after the DCI sizes that have the first format and the third format and that are all used to schedule downlink data transmission are aligned, the plurality of DCI sizes that have the first format and the third format and that are respectively used to schedule uplink data transmission and downlink data transmission may be aligned.

The example in which the plurality of DCI formats include {0_0, 0_2, 0_3, 1_0, 1_2, and 1_3} is still used. DCI sizes corresponding to the DCI formats are different. The DCI sizes corresponding to the DCI format 0_0 and the DCI format 1_0 may be preferably aligned, and a size obtained after the alignment is A. If the preset condition is still not met after the alignment, the DCI sizes corresponding to the DCI format 0_2 and the DCI format 0_3 may be aligned, and a size obtained after the alignment is B. If the preset condition is still not met after the alignment, the DCI sizes corresponding to the DCI format 1_2 and the DCI format 1_3 may be aligned, and a size obtained after the alignment is C. In this case, the quantity of different DCI sizes corresponding to the plurality of DCI formats is 3, and the preset condition may be met. Similarly, if a determining result is that the preset condition is met after an alignment operation is performed each time, a subsequent alignment step may be stopped.

In embodiments of this application, the DCI sizes corresponding to different formats are preferably aligned. This is based on consideration that if there is a relatively large difference between uplink and downlink bandwidths, and there is also a relatively large difference between a quantity of DCI bits corresponding to an uplink and a quantity of DCI bits corresponding to a downlink. DCI sizes in different formats and correspondingly used to schedule uplink data transmission are preferably aligned, or DCI sizes in different formats and correspondingly used to schedule downlink data transmission are preferably aligned. This may reduce redundancy of a quantity of bits and improve utilization of transmission resources.

In some embodiments, the plurality of DCI formats may include a DCI format detected in a CSS and a DCI format detected in a USS. When the plurality of DCI formats include both the DCI format detected in the CSS and the DCI format detected in the USS, DCI sizes corresponding to the DCI format detected in the CSS may be preferably aligned.

For ease of understanding, the following provides several specific examples based on Embodiment 1.

### Example 1

A plurality of DCI formats configured by a network device for a terminal device include DCI formats 0_0, 0_1, 0_3, 1_0, 1_1, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS to the DCI formats 0_0 and 1_0 configured in the CSS. A size obtained after the alignment is A.
(3) If the preset condition is not met, perform size alignment on the DCI formats 0_1 and 1_1 configured in the USS. A size obtained after the alignment is B.
(4) If the preset condition is not met, perform size alignment on the DCI formats 0_3 and 1_3 configured in the USS. A size obtained after the alignment is C.

### Example 2

A plurality of DCI formats configured by a network device for a terminal device include DCI formats 0_0, 0_1, 0_3, 1_0, 1_1, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS to the DCI formats 0_0 and 1_0 configured in the CSS. A size obtained after the alignment is A.
(3) If the preset condition is not met, perform size alignment on the DCI formats 0_3 and 1_3 configured in the USS. A size obtained after the alignment is B.
(4) If the preset condition is not met, perform size alignment on the DCI formats 0_1 and 1_1 configured in the USS. A size obtained after the alignment is C.

### Example 3

A plurality of DCI formats configured by a network device for a terminal device include DCI formats 0_0, 0_1, 0_3, 1_0, 1_1, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS to the DCI formats 0_0 and 1_0 configured in the CSS. A size obtained after the alignment is A.
(3) If the preset condition is not met, perform size alignment on the DCI formats 0_1 and 0_3 configured in the USS. A size obtained after the alignment is B.
(4) If the preset condition is not met, perform size alignment on the DCI formats 1_1 and 1_3 configured in the USS. A size obtained after the alignment is C.

### Example 4

A plurality of DCI formats configured by a network device for a terminal device include DCI formats 0_0, 0_1, 0_3, 1_0, 1_1, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS to the DCI formats 0_0 and 1_0 configured in the CSS. A size obtained after the alignment is A.
(3) If the preset condition is not met, perform size alignment on the DCI formats 1_1 and 1_3 configured in the USS. A size obtained after the alignment is B.
(4) If the preset condition is not met, perform size alignment on the DCI formats 0_1 and 0_3 configured in the USS. A size obtained after the alignment is C.

### Example 5

A plurality of DCI formats configured by a network device for a terminal device include DCI formats 0_0, 0_1, 0_2, 0_3, 1_0, 1_1, 1_2, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS and to the DCI formats 0_0 and 1_0 configured in the CSS. A size obtained after the alignment is A.
(3) If the preset condition is not met, perform size alignment on the DCI formats 0_2 and 1_2 configured in the USS. A size obtained after the alignment is B.
(4) If the preset condition is not met, perform size alignment on the DCI formats 0_1 and 1_1 configured in the USS. A size obtained after the alignment is C.
(5) If the preset condition is not met, perform size alignment on the DCI formats 0_3 and 1_3 and the DCI formats 0_1 and 1_1 configured in the USS. A size obtained after the alignment is D.

It should be noted that, in some embodiments, that the size obtained after the alignment is D may refer to aligning the DCI formats 0_3 and 1_3 to the DCI formats 0_1 and 1_1. In this case, the size D obtained after the alignment is the same as the size C of the DCI formats 0_1 and 1_1, that is, D=C. In some embodiments, that the size obtained after the alignment is D may refer to aligning the DCI formats 0_1 and 1_1 to the DCI formats 0_3 and 1_3. In this case, the size D obtained after the alignment is the same as a size of the DCI formats 0_3 and 1_3.

### Example 6

A plurality of DCI formats configured by a network device for a terminal device include DCI formats 0_0, 0_1, 0_2, 0_3, 1_0, 1_1, 1_2, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS to the DCI formats 0_0 and 1_0 configured in the CSS. A size obtained after the alignment is A.
(3) If the preset condition is not met, perform size alignment on the DCI formats 0_2 and 1_2 configured in the USS. A size obtained after the alignment is B.
(4) If the preset condition is not met, perform size alignment on the DCI formats 0_1 and 1_1 configured in the USS. A size obtained after the alignment is C.
(5) If the preset condition is not met, perform size alignment on the DCI formats 0_3 and 1_3 to the DCI formats 0_2 and 1_2 configured in the USS. A size obtained after the alignment is B.

### Example 7

A plurality of DCI formats configured by a network device for a terminal device include DCI formats 0_0, 0_1, 0_2, 0_3, 1_0, 1_1, 1_2, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS to the DCI formats 0_0 and 1_0 configured in the CSS. A size obtained after the alignment is A.
(3) If the preset condition is not met, perform size alignment on the DCI formats 0_2 and 1_2 configured in the USS. A size obtained after the alignment is B.
(4) If the preset condition is not met, perform size alignment on the DCI formats 0_1 and 1_1 configured in the USS. A size obtained after the alignment is C.
(5) If the preset condition is not met, perform size alignment on the DCI formats 0_3 and 1_3 configured in the USS. A size obtained after the alignment is D.
(6) If the preset condition is not met, perform size alignment on the DCI formats 0_1 and 1_1 and the DCI formats 0_2 and 1_2 configured in the USS. A size obtained after the alignment is E.

It should be noted that, in some embodiments, that the size obtained after the alignment is E may refer to aligning the DCI formats 0_2 and 1_2 to the DCI formats 0_1 and 1_1. In this case, the size E obtained after the alignment is the same as the size C of the DCI formats 0_1 and 1_1, that is, E=C. In some embodiments, that the size obtained after the alignment is E may refer to aligning the DCI formats 0_1 and 1_1 to the DCI formats 0_2 and 1_2. In this case, the size E obtained after the alignment is the same as the size B of the DCI formats 0_2 and 1_2, that is, E=B.

It should be noted that step (3) and step (4) may not be differentiated from each other in an execution sequence, that is, step (4) may be executed first, and then step (3) is executed.

### Example 8

A plurality of DCI formats configured by a network device for a terminal device include DCI formats 0_0, 0_1, 0_2, 0_3, 1_0, 1_1, 1_2, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS to the DCI formats 0_0 and 1_0 configured in the CSS. A size obtained after the alignment is A.
(3) If the preset condition is not met, perform size alignment on the DCI formats 0_3 and 1_3 configured in the USS. A size obtained after the alignment is B.
(4) If the preset condition is not met, perform size alignment on the DCI formats 0_1 and 1_1 configured in the USS. A size obtained after the alignment is C.
(5) If the preset condition is not met, perform size alignment on the DCI formats 0_2 and 1_2 to the DCI formats 0_3 and 1_3 configured in the USS. A size obtained after the alignment is B.

In some embodiments, step (4) and step (5) may not be differentiated from each other in an execution sequence, that is, step (5) may be executed first, and then step (4) is executed.

It should be noted that, in some embodiments, after step (3) is executed, the DCI formats 0_2 and 1_2 configured in the USS may be first aligned, and then the DCI formats 0_1 and 1_1 are aligned with the DCI formats 0_3 and 1_3.

### Example 9

A plurality of DCI formats configured by a network device for a terminal device include DCI formats 0_0, 0_1, 0_2, 0_3, 1_0, 1_1, 1_2, and 1_3 detected in a USS, and DCI formats 0_0 and 0_1 detected in a CSS.

If a quantity of different DCI sizes exceeds 4, or a quantity of DCI sizes of DCI scrambled by a C-RNTI exceeds 3, size alignment needs to be performed on the foregoing configured DCI formats. For a format of the DCI scrambled by the C-RNTI, steps of size alignment may be as follows.
(1) Perform size alignment on the DCI formats 0_0 and 1_0 configured in the CSS. A size obtained after the alignment is A.
(2) If a preset condition is not met, perform size alignment on the DCI formats 0_0 and 1_0 configured in the USS to the DCI formats 0_0 and 1_0 configured in the CSS. A size obtained after the alignment is A.
(3) If the preset condition is not met, perform size alignment on the DCI formats 0_3 and 1_3 configured in the USS. A size obtained after the alignment is B.
(4) If the preset condition is not met, perform size alignment on the DCI formats 0_1 and 1_1 configured in the USS. A size obtained after the alignment is C.
(5) If the preset condition is not met, perform size alignment on the DCI formats 0_2 and 1_2 and the DCI formats 0_1 and 1_1 configured in the USS. A size obtained after the alignment is D.

It should be noted that, in some embodiments, that the size obtained after the alignment is D may refer to aligning the DCI formats 0_2 and 1_2 to the DCI formats 0_1 and 1_1. In this case, the size D obtained after the alignment is the same as the size C of the DCI formats 0_1 and 1_1, that is, D=C. In some embodiments, that the size obtained after the alignment is D may refer to aligning the DCI formats 0_1 and 1_1 to the DCI formats 0_2 and 1_2. In this case, the size D obtained after the alignment is the same as a size of the DCI formats 0_2 and 1_2.

It should be noted that, in some embodiments, after step (3) is executed, the DCI formats 0_2 and 1_2 configured in the USS may be first aligned, and then the DCI formats 0_1 and 1_1 are aligned with the DCI formats 0_2 and 1_2.

In some embodiments, before the alignment processing is performed on the plurality of DCI formats, a type of configured DCI may also be first limited. Fewer DCI formats are configured to meet the preset condition, or when the preset condition is not met, in one aspect, processing may be performed by using a solution in the prior art. For example, the solution in the prior art may be performing alignment processing according to an existing alignment rule. For a specific alignment rule, refer to the prior art. Details are not described herein again. In another aspect, the alignment processing may be performed by using an alignment rule provided in embodiments of this application. For a specific alignment rule, refer to the foregoing description. Details are not described herein again.

With reference to Embodiment 2, the following describes in detail the type of the configured DCI.

### Embodiment 2

In some embodiments, a quantity of types of DCI formats corresponding to a first carrier is less than or equal to N, where N≤3, and the first carrier is one of at least two carriers scheduled by using DCI corresponding to a first format.

In some embodiments, the DCI formats corresponding to the first carrier may refer to a DCI format configured by a network device for a terminal device and used to schedule the first carrier. In some embodiments, the DCI formats corresponding to the first carrier may also refer to a DCI format configured in control (for example, config) signalling of a PDCCH corresponding to the first carrier.

In other words, the network device may configure a maximum of three different formats. For example, as described above, the first format includes the DCI format 0_3 and/or the DCI format 1_3, and an existing format in an NR system further includes the DCI format 0_0 and/or the DCI format 1_0, the DCI format 0_1 and/or the DCI format 1_1, and the DCI format 0_2 and/or the DCI format 1_2. The network device may select a maximum of three formats from the first format and the existing three formats (four formats in total) to configure for the terminal device. For example, the network device may configure two formats {0_0, 0_3, 1_0, 1_3} for the terminal device. Alternatively, the network device may configure three formats {0_0, 0_2, 0_3, 1_0, 1_2, 1_3} for the terminal device.

In some embodiments, a quantity of types of DCI formats supported by the first carrier within a first preset time is less than or equal to N, where N≤3. That is, the network device may configure a plurality of DCI formats for the terminal device, but the terminal device may support a maximum of three different DCI formats within a period of time.

Optionally, the first preset time may be a detection time (or referred to as duration) within a period of a search space. The search space may be a common search space (CSS) and/or a search space specific to a terminal device (UE-specific search space, USS). For example, the period of the search space may be 10 milliseconds. The terminal device may perform detection every 10 milliseconds, and each detection time is 5 milliseconds. In this case, the first preset time may be a period of time corresponding to the detection time (5 milliseconds).

Optionally, the first preset time may be configured by the network device. As an example, the first preset time may be a period of time that is directly configured by the network device. As another example, when the network device configures the first preset time, the first preset time may further include a period, duration, and the like.

It should be noted that a unit of the first preset time is not limited in embodiments of this application. For example, the unit of the first preset time may be millisecond, or the unit of the first preset time may be slot, symbol, or the like.

In addition to configuring the first format for the terminal device, the network device may further configure another DCI format for the terminal device. In other words, the first format may be one of a plurality of DCI formats configured by the network device for the terminal device. In some embodiments, the plurality of DCI formats may further include a fourth format, and the fourth format is a non-fallback format. For example, the fourth format may include at least one of following formats: DCI format 0_1, DCI format 1_1, DCI format 0_2, and DCI format 1_2.

In some embodiments, the terminal device does not expect to detect both the first format and the fourth format. In other words, the network device cannot configure both the first format and the fourth format at the same time for the terminal device. In this way, there are no more than three types of DCI formats that may be detected by the terminal device within a same time, so that processing may be performed by using an existing solution when a preset condition is not met. For example, when the fourth format includes at least one of the DCI format 0_1, the DCI format 1_1, the DCI format 0_2, and the DCI format 1_2, the fourth format may include the DCI format 0_1 and/or the DCI format 1_1; or the fourth format includes the DCI format 0_2 and/or the DCI format 1_2; or the fourth format includes at least one of the DCI format 0_1 and the DCI format 1_1, and at least one of the DCI format 0_2 and the DCI format 1_2.

In this case, that the terminal device does not expect to detect both the first format and the fourth format may mean that the terminal device does not expect to detect both the first format and the DCI format 0_1 or the DCI format 1_1; or the terminal device does not expect to detect both the first format and the DCI format 0_2 or the DCI format 1_2; or the terminal device does not expect to detect the first format and at least one of the DCI format 0_1 and the DCI format 1_1, and at least one of the DCI format 0_2 and the DCI format 1_2. That is, the first format cannot be configured for the terminal device together with DCI format x_1 and DCI format x_2 (x is 0 or 1), and may be configured for the terminal device together with at most one of DCI format x_1 and DCI format x_2 (the DCI format x_1 or the DCI format x_2).

In some embodiments, a type and configuration of a DCI format in a search space (a CSS and/or a USS) may be further limited. For example, it may be limited that the terminal device may support only a maximum of three different DCI formats in a detection time within a period of a search space. Alternatively, it may be limited that the terminal device may detect no more than three types of DCI formats in a search space. For example, the terminal device may detect no more than three types of DCI formats in a USS.

With reference to a specific example, the following provides a combination of DCI formats that may be configured by the network device for the terminal device when a quantity of types of DCI formats configured by the network device for a carrier corresponding to the terminal device is less than or equal to 3, or when a quantity of types of DCI formats supported by the terminal device within the first preset time is less than or equal to 3, or when the terminal device does not expect to detect both the first format and the fourth format.

In this example, the combination of the DCI formats that may be configured by the network device for the terminal device may include the following several types:
(1) {0_0, 1_0};
(2) {0_1, 1_1};
(3) {0_0, 0_3, 1_0, 1_3};
(4) {0_1, 0_3, 1_1, 1_3};
(5) {0_0, 0_1, 0_3, 1_0, 1_1, 1_3};
(6) {0_0, 0_2, 0_3, 1_0, 1_2, 1_3};
(7) {0_3, 1_3};
(8) {0_2, 0_3, 1_2, 1_3}; and
(9) {0_1, 0_2, 0_3, 1_1, 1_2, 1_3}.

The DCI format 0_3 and the DCI format 1_3 represent the first format. The DCI format 0_1, the DCI format 1_1, the DCI format 0_2, and the DCI format 1_2 represent the fourth format. In the nine combinations enumerated in this example, the first format is introduced in all of the combinations (3) to (9). It should be noted that this example is not used to limit all combinations of DCI formats that may be configured by the network device for the terminal device.

The foregoing describes method embodiments of this application in detail with reference to FIG. 1 to FIG. 4. The following describes apparatus embodiments of this application in detail with reference to FIG. 5 to FIG. 7. It should be understood that the description of the method embodiments corresponds to the description of the apparatus embodiments, and therefore, for parts that are not described in detail, refer to the foregoing method embodiments.

FIG. 5 is a schematic block diagram of a terminal device according to an embodiment of this application. The terminal device 500 shown in FIG. 5 may include a detection module 510.

The detection module 510 may be configured to detect DCI, where a format of the DCI is a first format, the DCI is used to schedule data transmission of at least two carriers, and the first format is one of a plurality of DCI formats; where if a quantity of DCI sizes corresponding to the plurality of DCI formats does not meet a preset condition, alignment processing is performed on DCI corresponding to the plurality of DCI formats to meet the preset condition.

Optionally, the alignment processing includes: aligning DCI sizes that have a same format and that are respectively used to schedule uplink data transmission and downlink data transmission.

Optionally, the aligning DCI sizes that have a same format and that are respectively used to schedule uplink data transmission and downlink data transmission includes: aligning DCI sizes that have a second format and that are respectively used to schedule uplink data transmission and downlink data transmission, where the second format is a fallback format; and if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have the first format and that are respectively used to schedule uplink data transmission and downlink data transmission.

Optionally, if the quantity of DCI sizes corresponding to the plurality of DCI formats still does not meet the preset condition after the DCI sizes that have the first format and that are respectively used to schedule uplink data transmission and downlink data transmission are aligned, DCI sizes that have a third format and that are respectively used to schedule uplink data transmission and downlink data transmission are aligned, where the third format is a non-fallback format.

Optionally, the aligning DCI sizes that have a same format and that are respectively used to schedule uplink data transmission and downlink data transmission includes: aligning DCI sizes that have a second format and that are respectively used to schedule uplink data transmission and downlink data transmission, where the second format is a fallback format; if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have a third format and that are respectively used to schedule uplink data transmission and downlink data transmission, where the third format is a non-fallback format; and if the quantity of DCI sizes corresponding to the plurality of DCI formats still does not meet the preset condition after the DCI sizes that have the third format and that are respectively used to schedule uplink data transmission and downlink data transmission are aligned, aligning DCI sizes that have the first format and that are respectively used to schedule uplink data transmission and downlink data transmission.

Optionally, the third format includes at least one of following formats: DCI format 0_1, DCI format 1_1, DCI format 0_2, and DCI format 1_2.

Optionally, if the quantity of DCI sizes corresponding to the plurality of DCI formats still does not meet the preset condition after the DCI sizes that have the same format and that are respectively used to schedule uplink data transmission and downlink data transmission are aligned, DCI sizes corresponding to different formats are aligned.

Optionally, the alignment processing includes: aligning DCI sizes corresponding to different formats.

Optionally, the aligning DCI sizes corresponding to different formats includes: aligning DCI sizes that have a second format and that are respectively used to schedule uplink data transmission and downlink data transmission, where the second format is a fallback format; and if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have the first format and a third format and that are all used to schedule downlink data transmission, where the third format is a non-fallback format.

Optionally, if the quantity of DCI sizes corresponding to the plurality of DCI formats still does not meet the preset condition after all the DCI sizes that have the first format and the third format and that are all used to schedule downlink data transmission are aligned, DCI sizes that have the first format and the third format and that are all used to schedule uplink data transmission are aligned.

Optionally, if the quantity of DCI sizes corresponding to the plurality of DCI formats still does not meet the preset condition after all the DCI sizes that have the first format and the third format and that are all used to schedule uplink data transmission are aligned, a plurality of DCI sizes that have the first format and the third format and that are respectively used to schedule uplink data transmission and downlink data transmission are aligned.

Optionally, DCI sizes that have a second format and that are respectively used to schedule uplink data transmission and downlink data transmission are aligned, where the second format is a fallback format; and if the quantity of DCI sizes corresponding to the plurality of DCI formats still does not meet the preset condition after the DCI sizes that have the second format and that are respectively used to schedule uplink data transmission and downlink data transmission are aligned, DCI sizes that have the first format and a third format and that are all used to schedule uplink data transmission are aligned, where the third format is a non-fallback format.

Optionally, if the quantity of DCI sizes corresponding to the plurality of DCI formats still does not meet the preset condition after all the DCI sizes that have the first format and the third format and that are all used to schedule uplink data transmission are aligned, DCI sizes that have the first format and the third format and that are all used to schedule downlink data transmission are aligned.

Optionally, if the quantity of DCI sizes corresponding to the plurality of DCI formats still does not meet the preset condition after all the DCI sizes that have the first format and the third format and that are all used to schedule downlink data transmission are aligned, a plurality of DCI sizes that have the first format and the third format and that are respectively used to schedule uplink data transmission and downlink data transmission are aligned.

Optionally, the third format includes at least one of following formats: DCI format 0_1, DCI format 1_1, DCI format 0_2, and DCI format 1_2.

Optionally, if the plurality of DCI formats include a DCI format detected in a common search space and a DCI format detected in a search space specific to the terminal device, DCI sizes corresponding to the DCI format detected in the common search space are preferably aligned.

Optionally, a quantity of types of DCI formats corresponding to a first carrier is less than or equal to N, N≤3, the DCI formats are configured by a network device, and the first carrier belongs to the at least two carriers.

Optionally, a quantity of types of DCI formats supported by a first carrier within a first preset time is less than or equal to N, N≤3, and the first carrier belongs to the at least two carriers.

Optionally, the first preset time is a detection time within a period of a search space, and the search space includes a common search space and/or a search space specific to the terminal device. Optionally, the first preset time is configured by a network device.

Optionally, the plurality of DCI formats further include a fourth format, the fourth format is a non-fallback format, and the terminal device does not expect to detect both the first format and the fourth format.

Optionally, the fourth format includes at least one of following formats: DCI format 0_1, DCI format 1_1, DCI format 0_2, and DCI format 1_2.

Optionally, the fourth format includes the DCI format 0_1 and/or the DCI format 1_1; or the fourth format includes the DCI format 0_2 and/or the DCI format 1_2; or the fourth format includes at least one of the DCI format 0_1 and the DCI format 1_1, and at least one of the DCI format 0_2 and the DCI format 1_2.

Optionally, the preset condition includes: a quantity of DCI sizes that are supported by a carrier corresponding to the terminal device is less than or equal to 4; or, a quantity of DCI sizes of DCI that is scrambled by a cell radio network temporary identifier C-RNTI and that is supported by a carrier corresponding to the terminal device is less than or equal to 3.

The terminal device 500 shown in FIG. 5 may be configured to implement the wireless communication method shown in FIG. 2. An actual implementation process is the same as content related to the foregoing method. For details, refer to the embodiment shown in FIG. 2. Details are not described herein again.

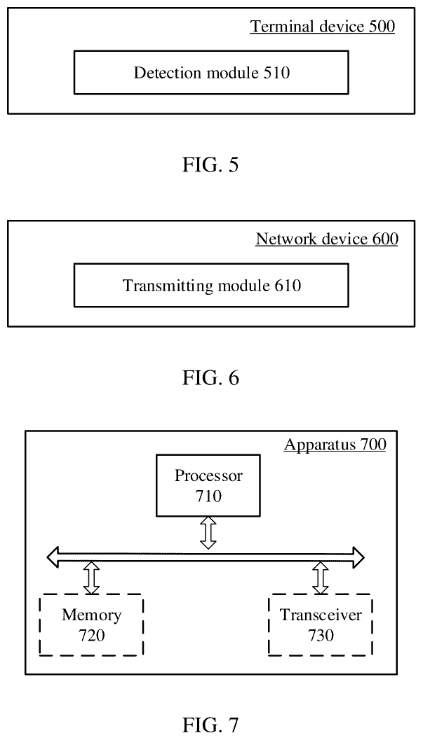

FIG. 6 is a schematic block diagram of a network device according to an embodiment of this application. The network device 600 shown in FIG. 6 may include a transmitting module 610.

The transmitting module 610 may be configured to transmit DCI to a terminal device, where a format of the DCI is a first format, and the DCI is used to schedule data transmission of at least two carriers.

Optionally, a quantity of types of DCI formats corresponding to a first carrier is less than or equal to N, where N≤3, the DCI formats are configured by the network device, and the first format is one of a plurality of DCI formats. If a quantity of DCI sizes corresponding to the plurality of DCI formats does not meet a preset condition, alignment processing is performed on DCI corresponding to the plurality of DCI formats to meet the preset condition.

Optionally, the alignment processing includes: aligning DCI sizes that have a same format and that are respectively used to schedule uplink data transmission and downlink data transmission.

Optionally, the aligning DCI sizes that have a same format and that are respectively used to schedule uplink data transmission and downlink data transmission includes: aligning DCI sizes that have a second format and that are respectively used to schedule uplink data transmission and downlink data transmission, where the second format is a fallback format; and if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have the first format and that are respectively used to schedule uplink data transmission and downlink data transmission.

Optionally, if the quantity of DCI sizes corresponding to the plurality of DCI formats still does not meet the preset condition after the DCI sizes that have the first format and that are respectively used to schedule uplink data transmission and downlink data transmission are aligned, DCI sizes that have a third format and that are respectively used to schedule uplink data transmission and downlink data transmission are aligned, where the third format is a non-fallback format.

Optionally, the aligning DCI sizes that have a same format and that are respectively used to schedule uplink data transmission and downlink data transmission includes: aligning DCI sizes that have a second format and that are respectively used to schedule uplink data transmission and downlink data transmission, where the second format is a fallback format; if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have a third format and that are respectively used to schedule uplink data transmission and downlink data transmission, where the third format is a non-fallback format; and if the quantity of DCI sizes corresponding to the plurality of DCI formats still does not meet the preset condition after the DCI sizes that have the third format and that are respectively used to schedule uplink data transmission and downlink data transmission are aligned, aligning DCI sizes that have the first format and that are respectively used to schedule uplink data transmission and downlink data transmission.

Optionally, the third format includes at least one of following formats: DCI format 0_1, DCI format 1_1, DCI format 0_2, and DCI format 1_2.

Optionally, if the quantity of DCI sizes corresponding to the plurality of DCI formats still does not meet the preset condition after the DCI sizes that have the same format and that are respectively used to schedule uplink data transmission and downlink data transmission are aligned, DCI sizes corresponding to different formats are aligned.

Optionally, the alignment processing includes: aligning DCI sizes corresponding to different formats.

Optionally, the aligning DCI sizes corresponding to different formats includes: aligning DCI sizes that have a second format and that are respectively used to schedule uplink data transmission and downlink data transmission, where the second format is a fallback format; and if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have the first format and a third format and that are all used to schedule downlink data transmission, where the third format is a non-fallback format.

Optionally, if the quantity of DCI sizes corresponding to the plurality of DCI formats still does not meet the preset condition after all the DCI sizes that have the first format and the third format and that are all used to schedule downlink data transmission are aligned, DCI sizes that have the first format and the third format and that are all used to schedule uplink data transmission are aligned.

Optionally, if the quantity of DCI sizes corresponding to the plurality of DCI formats still does not meet the preset condition after all the DCI sizes that have the first format and the third format and that are all used to schedule uplink data transmission are aligned, a plurality of DCI sizes that have the first format and the third format and that are respectively used to schedule uplink data transmission and downlink data transmission are aligned.

Optionally, DCI sizes that have a second format and that are respectively used to schedule uplink data transmission and downlink data transmission are aligned, where the second format is a fallback format; and if the quantity of DCI sizes corresponding to the plurality of DCI formats still does not meet the preset condition after the DCI sizes that have the second format and that are respectively used to schedule uplink data transmission and downlink data transmission are aligned, DCI sizes that have the first format and a third format and that are all used to schedule uplink data transmission are aligned, where the third format is a non-fallback format.

Optionally, if the quantity of DCI sizes corresponding to the plurality of DCI formats still does not meet the preset condition after all the DCI sizes that have the first format and the third format and that are all used to schedule uplink data transmission are aligned, DCI sizes that have the first format and the third format and that are all used to schedule downlink data transmission are aligned.

Optionally, if the quantity of DCI sizes corresponding to the plurality of DCI formats still does not meet the preset condition after all the DCI sizes that have the first format and the third format and that are all used to schedule downlink data transmission are aligned, a plurality of DCI sizes that have the first format and the third format and that are respectively used to schedule uplink data transmission and downlink data transmission are aligned.

Optionally, the third format includes at least one of following formats: DCI format 0_1, DCI format 1_1, DCI format 0_2, and DCI format 1_2.

Optionally, if the plurality of DCI formats include a DCI format detected in a common search space and a DCI format detected in a search space specific to the terminal device, DCI sizes corresponding to the DCI format detected in the common search space are preferably aligned.

Optionally, a quantity of types of DCI formats corresponding to a first carrier is less than or equal to N, N≤3, the DCI formats are configured by the network device, and the first carrier belongs to the at least two carriers.

Optionally, a quantity of types of DCI formats supported by a first carrier within a first preset time is less than or equal to N, N≤3, and the first carrier belongs to the at least two carriers.

Optionally, the first preset time is a detection time within a period of a search space, and the search space includes a common search space and/or a search space specific to the terminal device. Optionally, the first preset time is configured by the network device.

Optionally, the plurality of DCI formats further include a fourth format, the fourth format is a non-fallback format, and the network device cannot configure both the first format and the fourth format for the terminal device.

Optionally, the fourth format includes at least one of following formats: DCI format 0_1, DCI format 1_1, DCI format 0_2, and DCI format 1_2.

Optionally, the fourth format includes the DCI format 0_1 and/or the DCI format 1_1; or the fourth format includes the DCI format 0_2 and/or the DCI format 1_2; or the fourth format includes at least one of the DCI format 0_1 and the DCI format 1_1, and at least one of the DCI format 0_2 and the DCI format 1_2.

Optionally, the preset condition includes: a quantity of DCI sizes that are supported by a carrier corresponding to the terminal device is less than or equal to 4; or, a quantity of DCI sizes of DCI that is scrambled by a cell radio network temporary identifier C-RNTI and that is supported by a carrier corresponding to the terminal device is less than or equal to 3.

The terminal device 600 shown in FIG. 6 may be configured to implement the wireless communication method shown in FIG. 2. An actual implementation process is the same as content related to the foregoing method. For details, refer to the embodiment shown in FIG. 2. Details are not described herein again.

FIG. 7 is a schematic structural diagram of a communications apparatus according to an embodiment of this application. The dashed lines in FIG. 7 indicate that the unit or module is optional. The apparatus 700 may be configured to implement the methods described in the foregoing method embodiments. The apparatus 700 may be a chip, a terminal device, or a network device.

The apparatus 700 may include one or more processors 710. The processor 710 may allow the apparatus 700 to implement the methods described in the foregoing method embodiments. The processor 710 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 700 may further include one or more memories 720. The memory 720 stores a program. The program may be executed by the processor 710, to cause the processor 710 to perform the methods described in the foregoing method embodiments. The memory 720 may be independent of the processor 710 or may be integrated into the processor 710.

The apparatus 700 may further include a transceiver 730. The processor 710 may communicate with another device or chip through the transceiver 730. For example, the processor 710 may transmit and receive data to and from another device or chip through the transceiver 730.

An embodiment of this application further provides a computer-readable storage medium, configured to store a program. The computer-readable storage medium may be applied to a terminal or a network device provided in embodiments of this application, and the program causes a computer to execute a method to be performed by the terminal or the network device in various embodiments of this application.

An embodiment of this application further provides a computer program product. The computer program product includes a program. The computer program product may be applied to a terminal or a network device provided in embodiments of this application, and the program causes a computer to execute a method to be performed by the terminal or the network device in various embodiments of this application.

An embodiment of this application further provides a computer program. The computer program may be applied to a terminal or a network device provided in embodiments of this application, and the computer program causes a computer to execute a method to be performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In embodiments of this application, “B that is corresponding to A” means that B is associated with A, and B may be determined based on A. However, it should also be understood that, determining B based on A does not mean determining B based only on A; instead, B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” can be implemented by pre-storing a corresponding code or table in a device (for example, including the terminal device and the network device) or in other manners that can be used for indicating related information, and a specific implementation thereof is not limited in this application. For example, predefining may refer to being defined in a protocol.

In embodiments of this application, the “protocol” may refer to a standard protocol in the communication field, which may include, for example, an LTE protocol, an NR protocol, and a related protocol applied to a future communications system, and this application is not limited in this regard.

In embodiments of this application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solution of this embodiment.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
detecting, by a terminal device, downlink control information (DCI), wherein a format of the DCI is a first format, the DCI is used to schedule data transmission of at least two carriers, and the first format is one of a plurality of DCI formats; wherein if a quantity of DCI sizes corresponding to the plurality of DCI formats does not meet a preset condition, alignment processing is performed on DCI corresponding to the plurality of DCI formats to meet the preset condition.

2. The method according to claim 1, wherein the alignment processing comprises: aligning DCI sizes that have a same format and that are respectively used to schedule uplink data transmission and downlink data transmission.

3. The method according to claim 2, wherein the aligning DCI sizes that have a same format and that are respectively used to schedule uplink data transmission and downlink data transmission comprises:
aligning DCI sizes that have a second format and that are respectively used to schedule uplink data transmission and downlink data transmission, wherein the second format is a fallback format; and
if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have the first format and that are respectively used to schedule uplink data transmission and downlink data transmission.

4. The method according to claim 3, wherein if the quantity of DCI sizes corresponding to the plurality of DCI formats still does not meet the preset condition after the DCI sizes that have the first format and that are respectively used to schedule uplink data transmission and downlink data transmission are aligned, DCI sizes that have a third format and that are respectively used to schedule uplink data transmission and downlink data transmission are aligned, wherein the third format is a non-fallback format.

5. The method according to claim 2, wherein the aligning DCI sizes that have a same format and that are respectively used to schedule uplink data transmission and downlink data transmission comprises:
aligning DCI sizes that have a second format and that are respectively used to schedule uplink data transmission and downlink data transmission, wherein the second format is a fallback format;
if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have a third format and that are respectively used to schedule uplink data transmission and downlink data transmission, wherein the third format is a non-fallback format; and
if the quantity of DCI sizes corresponding to the plurality of DCI formats still does not meet the preset condition after the DCI sizes that have the third format and that are respectively used to schedule uplink data transmission and downlink data transmission are aligned, aligning DCI sizes that have the first format and that are respectively used to schedule uplink data transmission and downlink data transmission.

6. The method according to claim 4, wherein the third format comprises at least one of following formats: DCI format 0_1, DCI format 1_1, DCI format 0_2, and DCI format 1_2.

7. The method according to claim 2, wherein if the quantity of DCI sizes corresponding to the plurality of DCI formats still does not meet the preset condition after the DCI sizes that have the same format and that are respectively used to schedule uplink data transmission and downlink data transmission are aligned, DCI sizes corresponding to different formats are aligned.

8. The method according to claim 1, wherein the alignment processing comprises: aligning DCI sizes corresponding to different formats.

9. The method according to claim 8, wherein the aligning DCI sizes corresponding to different formats comprises:
aligning DCI sizes that have a second format and that are respectively used to schedule uplink data transmission and downlink data transmission, wherein the second format is a fallback format; and
if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have the first format and a third format and that are all used to schedule downlink data transmission, wherein the third format is a non-fallback format.

10. The method according to claim 9, wherein if the quantity of DCI sizes corresponding to the plurality of DCI formats still does not meet the preset condition after all the DCI sizes that have the first format and the third format and that are all used to schedule downlink data transmission are aligned, DCI sizes that have the first format and the third format and that are all used to schedule uplink data transmission are aligned.

11. The method according to claim 10, wherein if the quantity of DCI sizes corresponding to the plurality of DCI formats still does not meet the preset condition after all the DCI sizes that have the first format and the third format and that are all used to schedule uplink data transmission are aligned, a plurality of DCI sizes that have the first format and the third format and that are respectively used to schedule uplink data transmission and downlink data transmission are aligned.

12. The method according to claim 8, wherein the aligning DCI sizes corresponding to different formats comprises:
aligning DCI sizes that have a second format and that are respectively used to schedule uplink data transmission and downlink data transmission, wherein the second format is a fallback format; and
if the quantity of DCI sizes corresponding to the plurality of DCI formats still does not meet the preset condition after the DCI sizes that have the second format and that are respectively used to schedule uplink data transmission and downlink data transmission are aligned, aligning DCI sizes that have the first format and a third format and that are all used to schedule uplink data transmission, wherein the third format is a non-fallback format.

13. The method according to claim 12, wherein if the quantity of DCI sizes corresponding to the plurality of DCI formats still does not meet the preset condition after all the DCI sizes that have the first format and the third format and that are all used to schedule uplink data transmission are aligned, DCI sizes that have the first format and the third format and that are all used to schedule downlink data transmission are aligned.

14. The method according to claim 13, wherein if the quantity of DCI sizes corresponding to the plurality of DCI formats still does not meet the preset condition after all the DCI sizes that have the first format and the third format and that are all used to schedule downlink data transmission are aligned, a plurality of DCI sizes that have the first format and the third format and that are respectively used to schedule uplink data transmission and downlink data transmission are aligned.

15. The method according to claim 9, wherein the third format comprises at least one of following formats: DCI format 0_1, DCI format 1_1, DCI format 0_2, and DCI format 1_2.

16. The method according to claim 1, wherein if the plurality of DCI formats comprise a DCI format detected in a common search space and a DCI format detected in a search space specific to the terminal device, DCI sizes corresponding to the DCI format detected in the common search space are preferably aligned.

17. The method according to claim 1, wherein the plurality of DCI formats further comprise a fourth format, the fourth format is a non-fallback format, and the terminal device does not expect to detect both the first format and the fourth format.

18. The method according to claim 17, wherein the fourth format comprises at least one of following formats: DCI format 0_1, DCI format 1_1, DCI format 0_2, and DCI format 1_2.

19. A network device, comprising at least one processor, and at least one memory including a computer program, wherein the at least one memory and the at least one processor are configured with the computer program, to cause the network device at least to:
transmit downlink control information (DCI) to a terminal device, wherein a format of the DCI is a first format, the DCI is used to schedule data transmission of at least two carriers, and the first format is one of a plurality of DCI formats; wherein if a quantity of DCI sizes corresponding to the plurality of DCI formats does not meet a preset condition, alignment processing is performed on DCI corresponding to the plurality of DCI formats to meet the preset condition.

20. A terminal device, comprising at least one processor, and at least one memory including a computer program, wherein the at least one memory and the at least one processor are configured with the computer program, to cause the terminal device at least to:
detect downlink control information (DCI), wherein a format of the DCI is a first format, the DCI is used to schedule data transmission of at least two carriers, and the first format is one of a plurality of DCI formats; wherein if a quantity of DCI sizes corresponding to the plurality of DCI formats does not meet a preset condition, alignment processing is performed on DCI corresponding to the plurality of DCI formats to meet the preset condition.
